(19) United States
(12) Patent Application Publication
(10) Pub. No.: US 2007/0074200 A1
(43) Pub. Date: Mar. 29, 2007

(54) Function selection system and method

(75) Inventors: Fu-Hsiang Huang, Tu-Cheng (TW); Hsi-Chang Yang, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/321,314

(22) Filed: Dec. 29, 2005

(30) Foreign Application Priority Data
May 29, 2005 (CN) 200510034988.4

(51) Int. Cl. G06F 9/44

(52) U.S. Cl. 717/168; 717/106

(57) ABSTRACT

A function selection system (1) includes a firmware module (10), a querying interface (20), and a customer data module (30). The firmware module includes a plurality of programs for performing different functions. The customer data module is used for saving customer data. The customer data includes statuses of the different functions performed by the firmware module according to the different function requirements of different customers. The querying interface is used for querying the customer data in the customer data module according to a request received by the firmware module for performing a particular function, and for generating a corresponding instruction according to a querying result. A corresponding function selection method is also provided.

### BACKGROUND OF THE INVENTION

1. Field of the Invention

The present invention pertains to function selection systems and methods used in computing, and particularly to a system and method for selecting functions in embedded systems.

2. Related Art

Embedded systems are usually designed to perform designated functions. The architecture of an embedded system is often intentionally simplified compared to general-purpose computing hardware. Thus the costs of embedded systems are lower than for general-purpose computing hardware, and embedded systems have become popular. Nowadays, mobile phones, set-top boxes, embedded servers, and personal digital assistants all have embedded systems.

Usually, embedded devices are firmware; that is, a combination of software and hardware. The software for performing different functions of embedded devices is first developed on a computer, and is then embedded in the hardware. Embedded devices are usually designed, according to requirements of customers, to perform designated functions. Thus, if different customers require different functions in the same type of embedded devices, manufacturers of the embedded devices must develop different software programs according to the differing requirements of the different customers, and then embed the software programs in the same type of hardware. It is inconvenient and inefficient for manufacturers to have to manage the various software programs.

Therefore, a heretofore unaddressed need exists in the industry to overcome the aforementioned deficiencies and inadequacies.

### SUMMARY

An exemplary embodiment of the present invention provides a function selection system for selecting functions in an embedded system. The function selection system includes a firmware module, a customer data module, and a querying interface. The firmware module includes a plurality of programs for performing different functions. The customer data module is used for saving customer data. The customer data includes statuses of the different functions performed by the firmware module according to the different function requirements of different customers. The querying interface is used for querying the customer data in the customer data module according to a request received by the firmware module for performing a particular function, and for generating a corresponding instruction according to a querying result.

An exemplary function selection method is also provided. The function selection method includes the steps of: receiving a request for performing a particular function; sending the request to a querying interface; querying customer data in a customer data module; and generating an instruction according to a querying result, and sending the instruction to a piece of firmware.

Thus a manufacturer of embedded devices can modify customer data in the customer data module, according to the requirements of different customers for different functions in the same firmware module. Therefore the manufacturer can save time on developing and handling software programs, and can conveniently manage the software.

Other advantages and novel features will become more apparent from the following detailed description when taken in conjunction with the accompanying drawings, in which:

### BRIEF DESCRIPTION OF THE DRAWINGS

FIG. 1 is a block diagram of a function selection system of an exemplary embodiment of the present invention;

FIG. 2 is a schematic diagram of a data format of customer data of an exemplary embodiment of the present invention;

FIG. 3 is a schematic diagram of a data format of customer data of another exemplary embodiment of the invention; and

FIG. 4 is a flow chart of a function selection method of still another exemplary embodiment of the invention.

### DETAILED DESCRIPTION OF THE EMBODIMENTS

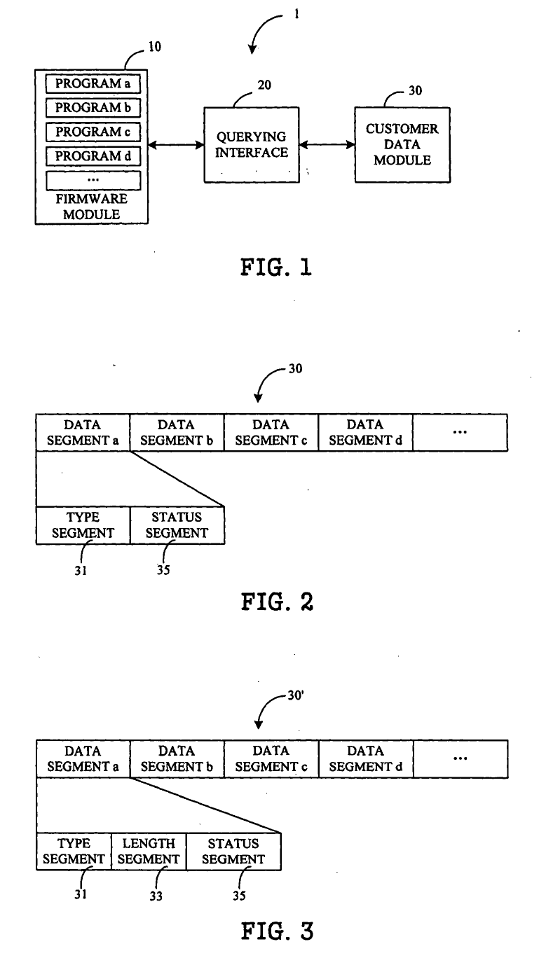

FIG. 1 is a block diagram of a function selection system 1 of an exemplary embodiment of the present invention. In the exemplary embodiment, the function selection system 1 is utilized in embedded systems. In the exemplary embodiment, the function selection system 1 includes a firmware module 10, a querying interface 20, and a customer data module 30. The firmware module 10 is a piece of hardware embedded with software. The software of the firmware module 10 includes a plurality of programs, such as program a, program b, program c, program d, and so on. Every program can independently perform a function. In the exemplary embodiment, when embedded systems using the function selection system 1 are provided to different customers, the firmware module 10 of the function selection system 1 in every embedded system includes the same programs.

The customer data module 30 is used for saving customer data. The customer data, written by a manufacturer, comprises the statuses of all functions performed by the firmware module 10 according to the different function requirements of different customers. The status for each function includes an enabled status and a disabled status. FIG. 2 is a schematic diagram of a data format of the customer data of the exemplary embodiment. In the exemplary embodiment, the customer data includes a plurality of data segments such as data segment a, data segment b, data segment c, data segment d, and so on. Each data segment corresponds to a respective program and its function in the firmware module 10; that is, data segment a corresponds to program a; data segment b corresponds to program b; data segment c corresponds to program c; and data segment d corresponds to program d. When the embedded systems with the function selection system 1 are provided to the different customers, the same data segments are contained in each of the customer data modules 30.

Each data segment includes a type segment 31 and a status segment 35. The type segment 31 represents a function, and is defined by the manufacturer. When the manufacturer provides embedded systems with the function selection system 1 to different customers, the type segment 31 of the data segments are the same. The status segment 35 comprises a value of the type segment 31, and shows the status of the function represented by the type segment 31. In the exemplary embodiment, the status of the function represented by the type segment 31 includes an enabled status and a disabled status. The status segment 35 is defined by the manufacturer according to the function requirements of a particular customer. When the manufacturer provides the embedded system with the function selection system 1 to different customers, the status segments 35 of the same data segments may be different. In the exemplary embodiment, the enabled status is represented by “0,” and the disabled status is represented by “1.” In another embodiment, the enabled status is represented by “1,” and the disabled status is represented by “0.”

The customer data obtained by different customers are described in detail as follows. In the exemplary embodiment, when the manufacturer provides the embedded systems with the function selection system 1 to different customers with different function requirements, the modules of the function selection system 1 in the embedded systems of each customer are the same except for the customer data module 30. Suppose that the firmware module 10 has four available functions, a, b, c and d. The customer data in the customer data module 30 will then have four data segments, a, b, c and d.

In the exemplary embodiment, when a first customer needs to perform functions a and b, a second customer needs to perform functions b, c and d, and a third customer needs to perform functions a, b, c and d, the only difference in the three customers' respective function selection systems 1 is the status segments 35 thereof.

In the exemplary embodiment, the enabled status is represented by “0,” and the disabled status is represented by “1.” Thus the status segments 35 of the four data segments a, b, c, and d of the customer data of the first customer are respectively represented by 0, 0, 1 and 1. The status segments 35 of the four data segments a, b, c, and d of the customer data of the second customer are respectively represented by 1, 0, 0, 0. The status segments 35 of the four data segments a, b, c, and d of the customer data of the third customer are respectively represented by 0, 0, 0, 0.

When a customer needs to change their selection of available functions of the embedded system with the function selection system 1, the customer need only change the status segments 35 of the data segments corresponding to the functions that need to be changed. For instance, if the first customer needs to add function c and function d, and to disable function b, the status segment 35 of the data segment b can be changed to 1, and the status segments 35 of the data segments c and d can be both be changed to 0. Thus, the functions of the embedded system of the first customer are changed accordingly.

FIG. 3 is a schematic diagram of a data format of customer data in a customer data module 30′ of another exemplary embodiment of the invention. The difference from the above exemplary embodiment is that each data segment includes a length segment 33 in addition to the type segment 31 and the status segment 35. The length segment 33 is used for representing the length of the status segment 35. For example, in the exemplary embodiment, the statuses of the function represented by the type segment 31 only include the enabled status and the disabled status, and the status segment 35 is represented by “0” or “1.” In this situation, the length segment 33 is “1.” In another example, the statuses of the function represented by the type segment 31 may include more than two statuses; for example, the statuses of the function represented by the type segment 31 may include three statuses: the enabled status, the disabled status, and a default status. In this situation, the status segment 35 may be represented by “00,” “01,” or “10,” and the length segment 33 is “2.”

The querying interface 20 queries and analyses the customer data in the customer data module 30 according to a request received by the firmware module 10 for performing a function, and then generates a corresponding instruction. When the embedded system with the function selection system 1 is running, if the embedded system needs to perform a function, the embedded system sends a request for performing the function to the firmware module 10 of the function selection system 1. The firmware module 10 sends the request to the querying interface 20. The querying interface 20 first queries the type segments 31 of the customer data in the customer data module 30 to determine whether there is a data segment corresponding to the function. If there is no data segment corresponding to the function, the querying interface 20 generates a skip instruction, and sends the skip instruction to the firmware module 10. If there is a data segment corresponding to the function, the querying interface 20 queries the status segment 35 of the data segment corresponding to the function in order to determine whether the function is enabled or disabled. If the function is enabled, the querying interface 20 generates an instruction for performing a function corresponding to the data segment in the firmware module 10, and sends the instruction to the firmware module 10. If the function is disabled, the querying interface 20 generates a skip instruction, and sends the skip instruction to the firmware module 10.

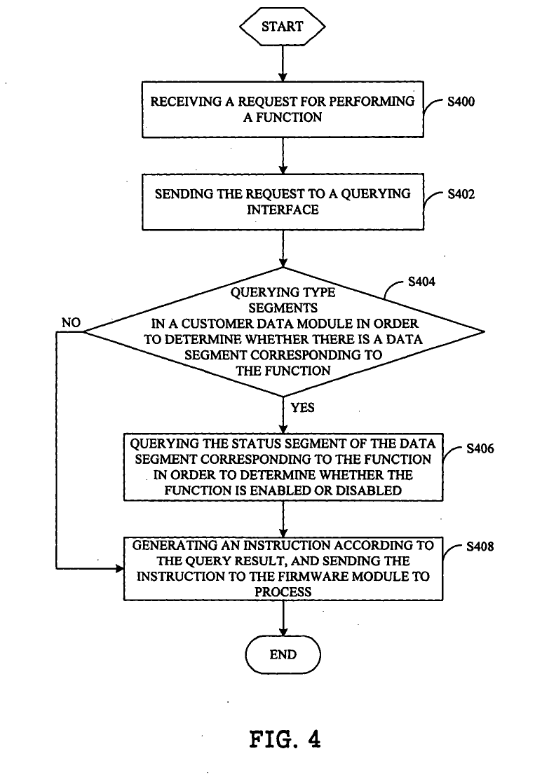

FIG. 4 is a flow chart of a function selection method of another exemplary embodiment of the invention. When the embedded system with the function selection system 1 is running and the embedded system needs to perform a function, the embedded system sends a request for performing the function to the firmware module 10 of the function selection system 1. In step S400, the firmware module 10 receives the request for performing the function. In step S402, the firmware module 10 sends the request to the querying interface 20. In step S404, according to the request, the querying interface 20 queries the type segments 31 in the customer data module 30 in order to determine whether there is a data segment corresponding to the function that needs to be performed. If the determination is no, the workflow proceeds directly to step S408 described below. If the determination is yes, in step S406, the querying interface 20 queries the status segment 35 of the data segment corresponding to the function in order to determine whether the function is enabled or disabled, whereupon the workflow proceeds to step S408.

In step S408, the querying interface 20 generates an instruction according to the querying result, and sends the instruction to the firmware module 10 to process. If the querying result is that there is no data segment corresponding to the function, or the querying result is that there is a data segment corresponding to the function but the function is disabled, the querying interface 20 generates a skip instruction, and sends the skip instruction to the firmware module 10. If the querying result is that there is a data segment corresponding to the function and the function is enabled, the querying interface 20 sends an instruction to perform that function to the firmware module 10.

The firmware module 10 of the function selection system 1 includes programs that can perform different functions to meet different customers' needs. Accordingly, the manufacturer can change the availability of the various functions to match the customers' needs by simply adjusting the statuses of the functions in the status segments 35 of the customer data in the customer data modules 30. Thus, it is easy and convenient for the manufacturer to manage the software of embedded systems.

While various embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

I claim:

1. A function selection system for an embedded system, comprising:
a firmware module, comprising a plurality of programs for performing different functions;
a customer data module, for saving customer data; and
a querying interface, for querying the customer data in the customer data module according to a request received by the firmware module for performing a particular function, and generating a corresponding instruction according to a querying result;
wherein the customer data comprise statuses of the different functions performed by the firmware module according to the different function requirements of different customers.

2. The function selection system as recited in claim 1, wherein the status of each of the functions comprises an enabled status and a disabled status.

3. The function selection system as recited in claim 1, wherein the customer data comprises a plurality of data segments, each of which corresponds to a program of the firmware module.

4. The function selection system as recited in claim 3, wherein each data segment comprises a type segment, for representing a particular function.

5. The function selection system as recited in claim 4, wherein each data segment further comprises a status segment, for showing the status of the function represented by the type segment.

6. The function selection system as recited in claim 5, wherein each data segment further comprises a length segment for representing a length of the status segment.

7. A function selection method, comprising steps of:
receiving a request for performing a particular function;
sending the request to a querying module;
querying customer data in a customer data module according to the request; and
generating an instruction according to a querying result, and sending the instruction to a firmware module.

8. The function selection method as recited in claim 7, wherein the customer data comprises a plurality of data segments.

9. The function selection method as recited in claim 8, wherein each data segment comprises a type segment for representing a particular function, and a status segment for showing a status of the function represented by the type segment.

10. The function selection method as recited in claim 9, wherein the querying step comprises querying the type segments of the customer data module, to determine whether there is a data segment corresponding to the function requested.

11. The function selection method as recited in claim 10, wherein the generating step comprises generating a skip instruction and sending the skip instruction to the firmware module if there is no data segment corresponding to the function requested.

12. The function selection method as recited in claim 10, wherein the querying step further comprises a step of querying the status segment of the data segment if there is a data segment corresponding to the function, to determine whether the function is enabled or disabled.

13. The function selection method as recited in claim 12, wherein the generating step comprises generating an instruction for performing a program corresponding to the data segment in the firmware module if the function is enabled, and sending the instruction to the firmware module.

14. The function selection method as recited in claim 12, wherein the generating step comprises generating a skip instruction if the function is disabled, and sending the skip instruction to the firmware module.

15. A method to selectively perform functions of a system, comprising the steps of:
identifying available user-defined functions capable of performing in a functional system;
recording a performing definition to each of said available functions in said system;
recording an accessible status of said each of said available functions together with said definition in said system; and
performing a selective function out of said available functions in said system when said selective function is identified as available and accessible based on said definition and said accessible status.

16. The method as recited in claim 15, wherein said system is a function embedded system.
